(19) United States
(12) Patent Application Publication
(10) Pub. No.: US 2026/0152052 A1
(43) Pub. Date: Jun. 4, 2026

(54) HYBRID DRIVE FLEXIBLE DRIVE COUPLING AND SHIPPABLE ASSEMBLY OF A HYBRID DRIVE WITH FLEXIBLE DRIVE COUPLING

(71) Applicant: Schaeffler Technologies AG & Co. KG, Herzogenaurach (DE)

(72) Inventor: Peter Rentfrow, Doylestown, OH (US)

(73) Assignee: Schaeffler technologies AG & Co. KG, Herzogenaurach (DE)

(21) Appl. No.: 18/966,429

(22) Filed: Dec. 3, 2024

(51) Int. Cl. B60K 6/26; B60K 6/24; B60K 6/405

(52) U.S. Cl. CPC B60K 6/26; B60K 6/24; B60K 6/405

(57) ABSTRACT

A drive arrangement for an engine, the drive arrangement, which can be a P1 hybrid or hybrid series generator arrangement, includes a drive housing and an Emotor including a stator and a rotor, with the stator being supported in the housing. A flex-plate coupling having at least two flex plates, with fasteners connecting end regions of the at least two flex plates, is provided, and a first flex-plate has openings that are adapted to receive fasteners for direct connection to an end of the engine crankshaft. A last of the flex plates is connected to the rotor. The rotor has a rotor support with a pilot at a first end that is received in a pilot opening in the end of the crankshaft and a second end with a support flange. A hub support is connected to the drive housing and rotatably supports the support flange of the rotor support.

### FIELD OF INVENTION

The disclosure relates to a hybrid drive architecture for hybrid electric vehicles. More specifically, it relates to a P1 hybrid drive architecture or a generator for a series hybrid having a flexible coupling between the Emotor rotor and the crankshaft.

### BACKGROUND

In a P1 hybrid architecture, an electric motor (Emotor) is integrated into the drivetrain with the rotor directly engaged with the crankshaft of the internal combustion engine (ICE), and torque from the Emotor and/or the ICE is transmitted via a transmission assembly, such as a clutch or torque converter to the transmission gear box.

Another hybrid arrangement is a series hybrid in which a motor is used to drive a generator, and electricity from the generator can be used to charge the batteries.

In P1 hybrids as well as series hybrid generator arrangements, the Emotor rotor has radial/angular movement due to the Emotor rotor being directly mounted to the engine crankshaft.

It would be desirable to find a cost-effective and space efficient solution for connecting the Emotor rotor to the crankshaft as well as to avoid or limit increases in space requirements, primarily in a longitudinal direction of the drive train.

### SUMMARY

In one aspect, a drive arrangement that is adapted for connection to an engine is provided. The drive arrangement includes a drive housing and an Emotor including a stator and a rotor, the stator being supported in the drive housing. A flex-plate coupling that includes at least two flex plates is provided, with fasteners connecting end regions of the at least two flex plates (outer end regions in embodiments with 2 flex plates, and alternate end regions if there are more than 2 of the flex plates). A first one of the at least two flex-plates includes openings that are adapted to receive fasteners, such as bolts, for direct connection to an end of a crankshaft of the engine, and a last of the at least two flex plates is connected to the rotor, for example via bolts, rivets or welds. The rotor includes a rotor support with a pilot at a first end that is adapted to be received in a pilot opening in the end of the crankshaft and a second end with a support flange. A hub support that is connected to the drive housing supports the support flange of the rotor support to allow for stable rotation of the rotor within the stator.

With this arrangement, a pre-assembled Emotor with a flex-plate coupling for connecting the rotor directly to the crankshaft is provided, which also provides rotatable support of the rotor within the stator. This can be used in a P1 hybrid drive arrangement as well as in a series hybrid generator arrangement.

In one embodiment, the hub support is removably connected to the housing to provide access for insertion of the fasteners for direct connection of the flex-plate coupling and the rotor to the end of the crankshaft.

In one embodiment, the hub support is integrally formed with the drive housing, and a rear wall of the drive housing that is adapted to face away from the engine in an installed position includes at least one access opening for insertion of the fasteners for direct connection of the flex-plate coupling to the end of the crankshaft.

In one embodiment, at least one of a bearing or bushing is provided between the rotor support and the hub support. The pilot can also include a pilot bearing or bushing.

In one embodiment, at least one access opening in at least one of the drive housing, the rotor support, or the flex-plate coupling is provided for insertion of the fasteners for direct connection of the flex-plate coupling to the end of the crankshaft.

In another aspect, in order to provide a drive arrangement with a pre-assembled Emotor with a flex-plate coupling that will not be damaged in shipping prior to being assembled to an engine, an engine side wall of the housing can be provided with a taper or bevel facing the flex-plate coupling, and opposite tapered or beveled supports are connected to or located on the flex-plate coupling that are adapted to be spaced apart from the taper or bevel on the engine side wall of the housing in an operating state of the drive arrangement. For shipping, a removable shipping ring is located between the hub support and the rotor that biases the flex-plate coupling so that the opposite tapered or beveled supports of the flex-plate coupling contact the taper or bevel on the engine side wall of the housing in a shipping state of the arrangement. This prevents damage to the stator and rotor during shipping when the pilot on the rotor support is unsupported.

In one embodiment, at least some of the opposite tapered or beveled supports of the flex-plate coupling are formed on fastener heads of fasteners used to connect the flex-plate coupling to the rotor.

In one embodiment, at least some of the opposite tapered or beveled supports of the flex-plate coupling are formed by a bent portion of the first one of the at least two flex-plates.

In one embodiment, the shipping ring includes a spring or resilient section that biases the rotor such that the flex plate is pressed against the taper or bevel on the engine side wall of the housing.

In one embodiment, the drive housing includes a radially outer wall and a rear wall, and the radially outer wall is adapted to be connected to a rear wall of the engine. Here bolt flanges may extend radially outwardly from the radially outer wall of the drive housing.

In one embodiment, a chamber is formed between the rear wall of the engine, the radially outer wall and the rear wall of the drive housing in which the stator and rotor are located. With this arrangement, the drive housing does not need a wall on the first end that faces the engine, saving space and weight. It is possible for the chamber to be a wet chamber, which uses transmission fluid for cooling. The chamber can also be dry and other cooling provided for the stator, such as a cooling jacket.

In one embodiment, the flex-plate coupling is located at least partially within the rotor in a longitudinal direction of the drive train. This provides a space-saving arrangement.

In one embodiment, the drive arrangement is a P1 hybrid drive arrangement, and an output shaft is drivingly connected to the rotor and extends through the support hub. The connection between the rotor and the output shaft can be a direct or a damped connection.

In a further aspect, a method of installing a drive arrangement on an engine is provided. The method includes providing a drive arrangement having one or more of the features disclosed herein, and for installation on the engine, removing the hub support, removing the shipping ring, inserting the pilot at the first end of the rotor support into the pilot opening in the end of the crankshaft, installing fasteners through the openings in the first one of the at least two flex plates to connect the flex-plate coupling to the end of the crankshaft, and reinstalling the hub support to rotatably support the support flange of the rotor support.

The method can also include fastening the drive housing to a rear wall of the engine.

In one embodiment, the step of installing the fasteners includes inserting the fasteners through at least one access opening in at least one of the drive housing, the rotor support, or the flex-plate coupling to the openings in the first one of the at least two flex plates for direct connection of the flex-plate coupling to the end of the crankshaft. Multiple access openings can be provided, or if one access opening is provided, the crankshaft can be rotated along with the rotor to align one of the fastener openings with the access opening to allow insertion/installation of a fastener before rotating to the next fastener opening.

In one embodiment, the flex-plate coupling is located at least partially within the rotor in a longitudinal direction of the drive train. This is a space saving feature which provides the benefits of a flex-plate coupling between the crankshaft and the rotor of the Emotor without an increase in space requirements at least in the longitudinal direction of the drive train.

Various features of the invention can be used alone or in combination in order to achieve one or more of the benefits described herein.

### BRIEF DESCRIPTION OF THE DRAWINGS

The foregoing Summary and the following detailed description will be better understood when read in conjunction with the appended drawings, which illustrate preferred embodiments according to the disclosure. In the drawings:

FIG. 1 is a cross-sectional view through a drive arrangement, shown as a series hybrid generator, in accordance with a first embodiment connected to an engine in an installed position.

FIG. 2 is a cross-sectional view of the drive arrangement shown in FIG. 1 in an as-shipped configuration prior to assembly to an engine, including a shipping ring that biases the rotor of the Emotor to a stable position.

FIG. 3 is a cross-section view of a drive arrangement as shown in FIGS. 1 and 2 shown in a first installation phase in which the drive housing is fastened to a rear wall of the engine which causes the rotor to move to an operating position by the shipping ring being compressed.

FIG. 4 is a cross-sectional view of the drive arrangement of FIGS. 1-3 showing the hub support and shipping ring removed in order to allow installation of fasteners for connecting the rotor via the flex-plate coupling to the crankshaft of the engine.

FIG. 5 is a cross-sectional view of a second embodiment of a drive arrangement, shown as a series hybrid generator, in which the hub support is formed integrally with the drive housing and both the drive housing and the rotor support of the Emotor rotor include access openings for installing fasteners to connect the flex-plate coupling, attached to the rotor, to the crankshaft.

FIG. 6 is a cross-sectional view of a third embodiment of the drive arrangement, shown as a series hybrid generator, similar to FIG. 1, in which the drive housing is shown without a front wall and the Emotor chamber is formed by a radially outer wall and a rear wall of the drive housing and a rear wall of the engine.

FIG. 7 is a cross-sectional view of a fourth embodiment of a drive arrangement, shown as a series hybrid generator, similar to FIG. 6 in which the flex-plate coupling between the rotor and the crankshaft is located at least partially within the rotor in a longitudinal direction of the drive train in order to conserve space in the longitudinal direction.

FIG. 8 is cross-sectional view of a further embodiment of a drive arrangement, shown as a series hybrid generator, similar to FIG. 6 in which the output shaft is drivingly engaged to the rotor via a flange that connects to the rotor support.

FIG. 9 is cross-sectional view of a further embodiment of a drive arrangement, shown as a series hybrid generator, similar to FIG. 6 in which the output shaft is drivingly engaged to the rotor via a damper arrangement that is connected between the rotor support and the output shaft.

### DETAILED DESCRIPTION

Certain terminology is used in the following description for convenience only and is not limiting. The words “inwardly” and “outwardly” refer to directions toward and away from the parts referenced in the drawings. “Axially” refers to a direction along the axis of a shaft. “Radially” refers to a direction normal to an axis. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terms “about” and “approximately” encompass +or −10% of an indicated value unless otherwise noted. The terminology includes the words specifically noted above, derivatives thereof and words of similar import.

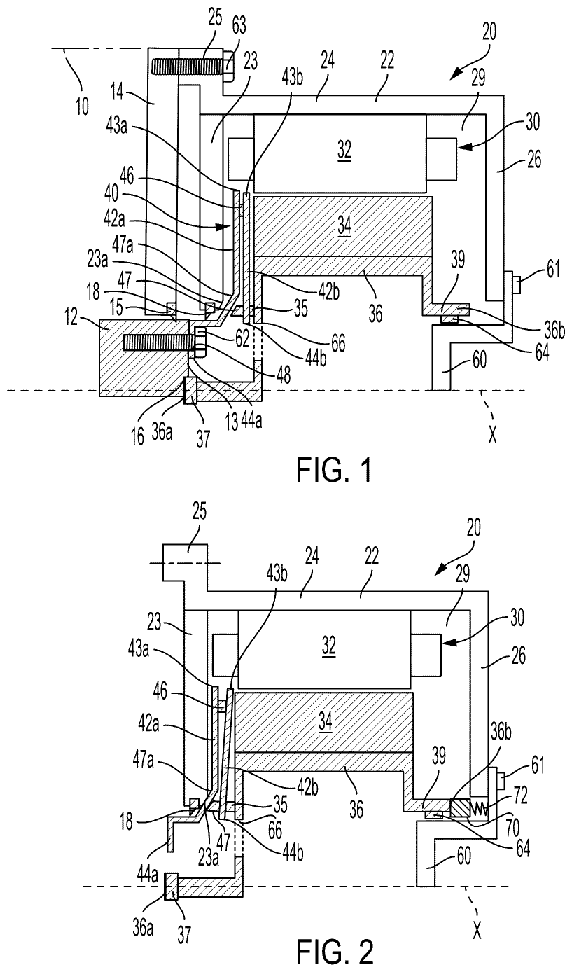

Referring to FIGS. 1-4 , a first embodiment of a drive arrangement 20, shown as a series hybrid generator, that is adapted for connection to an engine 10 is shown. The engine 10, schematically shown, includes a crankshaft 12 having an end 13, with the crankshaft 12 being supported by an engine block, the rear wall 14 of which is shown. A seal 15 extends between the rear wall 14 and the crankshaft 12.

The drive arrangement 20 includes a drive housing 22 in which an Emotor 30 including a stator 32 and a rotor 34 is assembled, with the stator 32 being supported in the drive housing 22. As shown, in the first embodiment of the drive arrangement 20, the drive housing 22 includes a front wall 23, a radially outer wall 24, with bolt flange(s) 25 extending from the radially outer wall 24, as well as a rear wall 26 that define a chamber 29 for the Emotor 30. As discussed in further detail below, the front wall 23 can be omitted, depending upon the particular application.

As shown in the assembled state in FIG. 1, as well as during assembly as shown in FIG. 4, a flex-plate coupling 40 is provided that includes at least two flex-plates 42a, 42b with fasteners 46 connecting regions 43a, 43b of the at least two flex plates 42a, 42b together. In the first embodiment, there are only two flex-plates 42a, 42b, and the first ends 43a, 43b are connected together with fasteners 46 which can be rivets. However, other types of fasteners could be used on the fasteners could be comprised of one or more welds. The flex-plates 42a, 42b also include second ends 44a, 44b. A first one of the at least two flex-plates 42a, 42b includes openings 48 at the second end 44a that are adapted to receive fasteners 62 for direct connection to the end 13 of the crankshaft 12 of the engine 10. While a single opening 48 is shown in the cross-sectional views in FIGS. 1-4 , there are preferably four or more equally spaced openings 48 located circumferentially about the longitudinal axis X.

In the illustrated embodiment of FIGS. 1-4 , the second or last of the two flex-plates 42b is connected to the rotor 34. This can be via a riveted, bolt, welded, or any other connection, with rivets 35 being shown. The rotor 34 includes a rotor support 36, and the rotor support 36 includes a pilot 37 at a first end 36a that is adapted to be received in a pilot opening 16 in the end 13 of the crankshaft 12 and the second end 36b includes a support flange 39.

As illustrated in FIG. 1 in the assembled state, a hub support 60 is connected to the drive housing 22, with fasteners 61, and rotatably supports the support flange 39 of the rotor support 36. At least one of a bearing or bushing 64 is provided between the rotor support 36 and the hub support 60.

In order to allow the drive arrangement 20 to be provided as a separate assembly that can be assembled and then shipped to a different location or site for assembly to the engine 10, the hub support 60 in the first embodiment of the drive arrangement 20 is removably connected to the housing 22, preferably via fasteners 61 which are threaded, to provide access for insertion of the fastener 62 for direct connection of the flex-plate coupling 40 to the end 13 of the crankshaft 12. The fasteners are shown in the assembled state of the drive arrangement 20 to the engine in FIG. 1 as well as during installation as shown in FIG. 4 where the fastener 62 can be inserted through the openings 48 in the first one of the at least two flex-plates 42a of the flex-plate coupling 40 in order to provide a direct driving connection between the crankshaft 12 and the rotor 34.

As shown in FIGS. 1-4, at least one access opening 66 is provided in the rotor support 36 in order to allow insertion of the fasteners 62 through the openings 48 and into the end 13 of the crankshaft 12.

In order to allow the drive arrangement 20 to be separately assembled and prevent movement of the rotor 34 within the stator 32, as shown in FIGS. 1-4, an engine sidewall 23 of the housing 22 includes a taper or bevel 23a facing the flex-plate coupling 40. Opposite tapered or beveled supports 47, 47a are connected to or located on the flex-plate coupling 40 that are spaced apart from the taper or bevel 23a on the engine sidewall 23 of the housing 22 in an operating state of the drive arrangement 20 (shown in FIG. 1), and a removable shipping ring 70, shown in FIGS. 2-4, is located between the hub support 60 and the rotor 34 and biases the flex-plate coupling 40 so that the opposite tapered or beveled supports 47, 47a of the flex-plate coupling 40 contact the taper or bevel 23a on the front wall 23 of the housing 22 or an adjacent flex plate 42a in a shipping state in order to provide a stabilized arrangement.

As shown in FIGS. 1-4, at least some of the opposite tapered or beveled supports 47a of the flex-plate coupling 40 can be formed by a bent portion of the first one of the at least two flex-plates 42a. As shown in FIG. 2, these opposite tapered or beveled supports 47a are pressed against the taper or bevel 23a on the engine sidewall 23 when the shipping ring 70 is installed. A further seal 18 is also shown that acts between the front wall 23 and the bent portion of the first one of the flex plates 42a. Additionally, at least some of the opposite tapered or beveled supports 47 of the flex-plate coupling 40 can be formed on fastener heads of the fasteners 35 used to connect the flex-plate coupling 40 to the rotor 34. These opposite tapered or beveled supports 47 contact the adjacent flex plate 42a when the shipping ring 70 is installed. If there are more than 2 of the flex plates 42a, 42b, additional ones of the supports can be provided.

As shown specifically in FIG. 2, the shipping ring 70 includes a spring or resilient section 72, illustrated schematically, that biases the rotor 34 such that the flex-plate 40 is pressed against the taper or bevel 23a on the engine sidewall 23 of the housing 22. This holds the rotor 34 in a stable position for shipping. The biasing can be via a leaf spring that is attached to or formed with the shipping ring 70 or could be formed by one or more coil springs or a belleville washer. Alternatively, the shipping ring 70 could have resilient material sections that provide the biasing force. The type of resilient biasing can vary depending on the particular application.

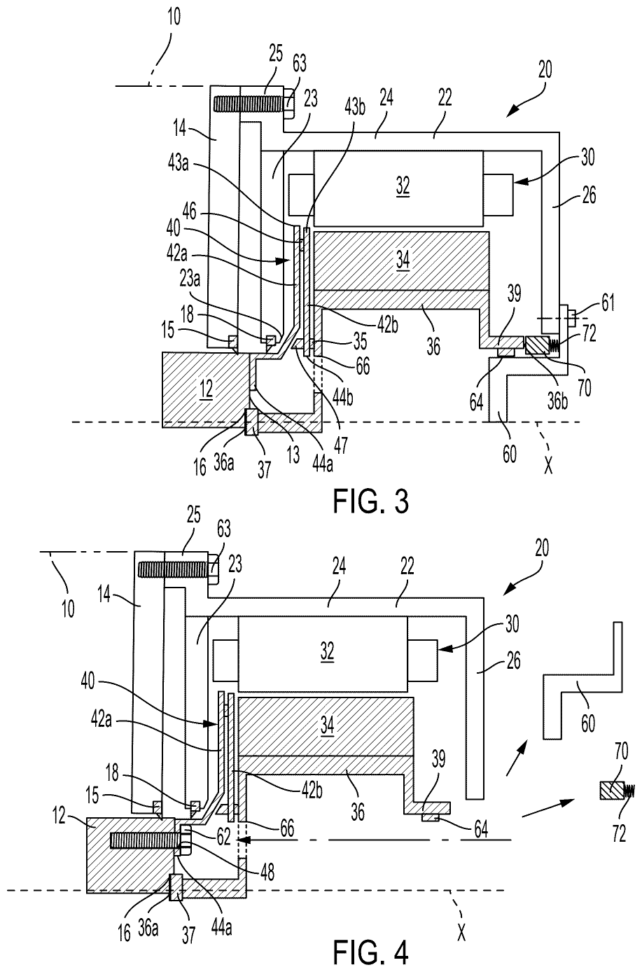

For assembling the drive arrangement 20 shown in FIGS. 1-4, the drive arrangement 20 is provided in the shipping state as shown in FIG. 2. As shown in FIG. 3, the drive arrangement 20 can be located against the rear wall 14 of the engine 10 and fasteners 63 installed through the bolt flanges 25 on the radially outer wall 24 of the drive housing 22. During the installation, the pilot 37 at the first end of the rotor support 36 is inserted into the pilot opening 16 in the end 13 of the crankshaft 12. Installing the bolts 63 moves the drive housing 22 against the rear wall 14 of the engine 10 and, when the flex-plate coupling 40 contacts the end 13 of the crankshaft 12, the flex-plate coupling 20 is moved via contact with the end 13 of the crankshaft 12 against the resilient force of the removable shipping ring 70 to an operating position, in which the flex-plate coupling 40 is not in contact with the taper or bevel 23a on the engine sidewall 23 of the housing 22 and the flex plates are spaced apart from any intermediate ones of the opposite tapered or beveled supports 47a between the flex plates 42a, 42b, etc. This state is shown in FIG. 3, prior to the flex-plate coupling 40 being connected to the crankshaft 12.

The shipping ring 70 is then removed by removing the hub support 60 that is removably connected to the rear wall 26 of the drive housing 22, for example via bolts or other removable or replaceable fasteners 61, such that the shipping ring 70 can be removed.

As shown in FIG. 4, the fasteners 62 are then installed via the access opening 66 in the rotor support 36 through the openings 48 to connect the flex-plate coupling 40 to the end 13 of the crankshaft 12.

After the fasteners 62 are installed, the hub support 60 is re-attached to the rear wall 26 of the drive housing 22.

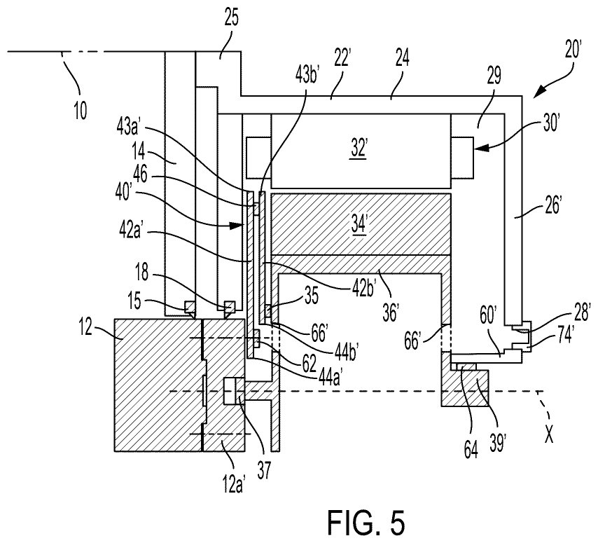

Referring now to FIG. 5, the second embodiment of the drive arrangement 20′ is similar to the drive arrangement 20. Like elements have the same reference numbers as explained above in connection with the first embodiment of the drive arrangement 20, and similar elements have the same reference number with a prime (′) added and the differences are described below. In the second embodiment of the drive arrangement 20′, the hub support 60′ is integrally formed with the drive housing 22′, and a rear wall 26′ of the drive housing 22′ that is adapted to face away from the engine 10 in an installed position includes at least one access opening 28′ for insertion of the fasteners 62 for direct connection of the rotor 34′ via the flex-plate coupling 40′, constructed from two flex plates 42a′, 42b′, to the end 13 of the crankshaft 12. The Emotor 30′ is similar to 30 and has the stator 32′ located within the housing 22′. The flex plates 42a′, 42b′ include first ends 43a′, 43b′ that are connected together via fasteners 46, and second ends 44a′, 44b′. The second end 44a′ of the first flex plate 42a′ has openings (similar to 48 above) for connection to the crankshaft 12 using fasteners 62. Here, as shown in FIG. 5, access holes 66′ are also provided on both sides of the rotor support 36′. With this arrangement, depending on the configuration of the engine 10, an optional spacer 12a′ can be provided at the end of the crankshaft 12. A removable plug 74′ for the access hole 28′ can also be provided. Additionally, this arrangement does not use the removable shipping ring 70 to hold the rotor 34′ in place in the shipping state and other arrangements can be used.

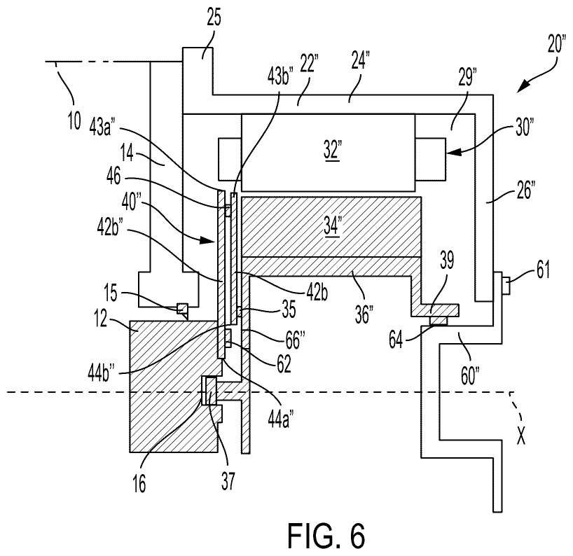

Referring now to FIG. 6, a third embodiment of a drive arrangement 20″ is shown. The third embodiment of the drive arrangement 20″ is similar to the second embodiment 20′. However, in this case the drive housing 22″ includes only the radial outer wall 24″ and the rear wall 26″, and the front wall has been omitted. The bolt flanges 25″ of the drive housing 22″ are fastened to the rear wall 14 of the engine 10 and in this case, the chamber 29″ is formed between the rear wall 14 of the engine 10, the radially outer wall 24″ and the rear wall 26″ of the drive housing 22″ in which the stator 32″ and rotor 34″ of the Emotor 30″ are located. In this case, the hub support 60″ is provided in order to allow access for installing the fasteners 62 for direct connection of the flex-plate coupling 40″, constructed from two flex plates 42a″, 42b″, to the end 13 of the crankshaft 12. The flex plates 42a″, 42b″ include first ends 43a″, 43b″ that are connected together via fasteners 46, and second ends 44a″, 44b″. The second end 44a″ of the first flex plate 42a″ has openings (similar to 48 above) for connection to the crankshaft 12 using fasteners 62. The second end 44b″ of the second flex plate 42b″ is connected to the rotor support 36″ via the fasteners 35. The rotor support 36″ also includes the access holes 66″ for installing the fasteners 62. Here, the removable shipping ring 70 is not provided and other means are used for stabilizing the rotor 34″ within the stator 32″ for the shipping state of the drive arrangement 20″.

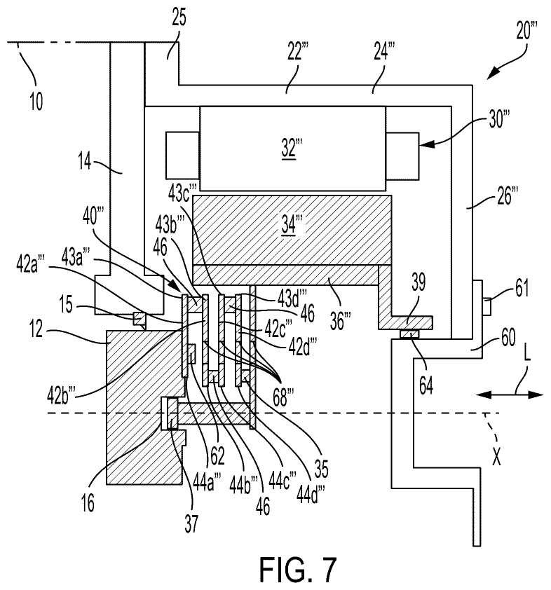

Referring now to FIG. 7, a fourth embodiment of a drive arrangement 20″ is shown. The fourth embodiment of the drive arrangement 20″ is similar to the third embodiment of the drive arrangement 20″ in that the drive housing 22″ does not include the front wall and the chamber 29″′ is formed between the rear wall 14 of the engine 10, the radial outer wall 24′″ of the drive housing 22″ and the rear wall 26′″ of the drive housing 22″. In order to conserve space in a longitudinal direction L of the drive train, take along the axis X, the flex-plate coupling 40′″ is located at least partially within the rotor 34′″. In this case, the configuration of the rotor support 36′″ is altered such that additional space is provided for the flex-plate coupling 40′″, which in this case is illustrated as including four flex plates 42a-d′″. The flex plates 42a′″, 42b′″, 42c′″, 42d′″ include first ends 43a′″, 43b′″ and 43c′″, 43d′″ that are respectively connected together via fasteners 46, and second ends 44a′″, 44b′″, 44c′″, 44d′″. The second end 44a′″ of the first flex plate 42a′″ has openings (similar to 48 above) for connection to the crankshaft 12 using fasteners 62. The second end 44d′″ of the last flex plate 42d′″ is connected to the rotor support 36″ via the fasteners 35. The second ends 44b′″ and 44c′″ of the second and third flex plates 42b′″. 42c′″ are connected together. This results in alternate end regions of the flex-plates 42a′″-d′″ being connected via the fasteners 46 in order to form the flex-plate coupling 40′″.

In this case, access for the insertion of the fastener 62 for direction connection of the flex-plate coupling 40′″ to the end 13 of the crankshaft 12 is provided by access openings 68′″ in the flex-plate coupling 40′″ as well as by removing the hub support 60.

In the fourth embodiment of the drive arrangement 20′″, the removable shipping ring 70 is not utilized and other means are provided for stabilizing the rotor 34 within the stator 32 for shipping.

In each of the above-described embodiments of the drive arrangement, which are shown as a series hybrid generator arrangement, 20, 20′, 20″, 20′″, during installation the fasteners 62 are inserted through at least one access opening 28′, 66, 66′, 66″, 68′″ in at least one of the drive housing 22′, the rotor support 36, 36′, 36″, or the flex-plate coupling 40 to the openings 48 in the first one of the at least two flex-plates 42a, 42a′, 42a″, 42a′″ to allow for direct connection of the flex-plate coupling 40, 40′, 40″, 40′″ as well as the Emotor rotor 34, 34′, 34″, 34′″ non-rotatably fixed thereto to the end 13 of the crankshaft 12.

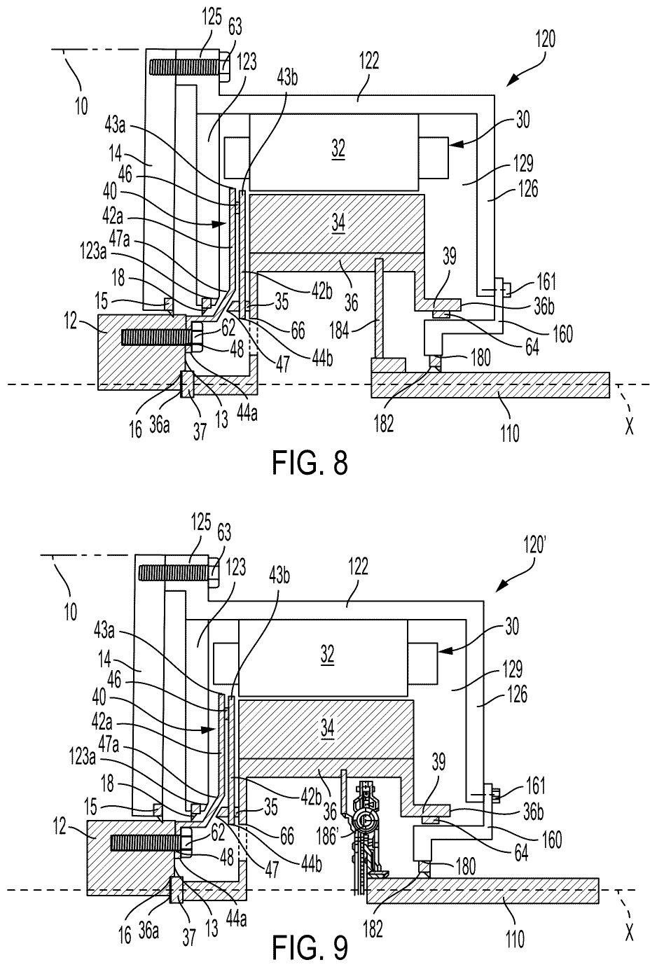

Referring now to FIGS. 8 and 9, two additional embodiments of a drive arrangement 120, 120′ are shown. The drive arrangements 120, 120′ are illustrated as P1 hybrid drive arrangements in which torque from the engine 10 and/or the Emotor 130 are transferred to an output shaft 110. Both drive arrangements 120,120′ are similar to the drive arrangement 20 described above. The drive arrangements 120, 120′ each include a drive housing 122 in which an Emotor 30 including a stator 32 and a rotor 34 is assembled, with the stator 32 being supported in the drive housing 122. The drive housing 122 includes a front wall 123, a radially outer wall 124, with bolt flange(s) 125 extending from the radially outer wall 124, as well as a rear wall 126 that define a chamber 129 for the Emotor 30. As discussed in further detail below, the front wall 123 can be omitted, depending upon the particular application.

As shown in the assembled state in FIGS. 8 and 9, the flex-plate coupling 40 as described above is provided that includes the at least two flex-plates 42a, 42b with fasteners 46 connecting regions 43a, 43b of the at least two flex plates 42a, 42b together. The flex-plates 42a, 42b also include second ends 44a, 44b. A first one of the at least two flex-plates 42a, 42b includes the openings 48 at the second end 44a that are adapted to receive fasteners 62 for direct connection to the end 13 of the crankshaft 12 of the engine 10. While a single opening 48 is shown in the cross-sectional views in FIGS. 8 and 9, there are preferably four or more equally spaced openings 48 located circumferentially about the longitudinal axis X.

In the embodiment of FIGS. 8 and 9, the second or last of the two flex-plates 42b is connected to the rotor 34. This can be via a riveted, bolt, welded, or any other connection, with rivets 35 being shown. The rotor 34 includes a rotor support 36, and the rotor support 36 includes a pilot 37 at a first end 36a that is adapted to be received in a pilot opening 16 in the end 13 of the crankshaft 12 and the second end 36b includes a support flange 39.

As illustrated in FIGS. 8 and 9 in the assembled state, a hub support 160 is connected to the drive housing 122, with fasteners 161, and rotatably supports the support flange 39 of the rotor support 36. At least one of a bearing or bushing 64 is provided between the rotor support 36 and the hub support 160. Additionally, an opening 180 is defined in the hub support 160 through which the output shaft 110 extends. A seal 182 is provided to seal the opening 180 between the hub support 160 and the output shaft 110.

In the embodiment of the drive arrangement 120 shown in FIG. 8, the output shaft 110 is drivingly engaged to the rotor 34 via a flange 184 that connects to the rotor support 36.

In the embodiment of the drive arrangement 120′shown in FIG. 9, the output shaft 110 is drivingly engaged to the rotor 34 via a damper arrangement 186′ that is connected between the rotor support 36 and the output shaft 110 in order to compensate for vibration and deviations in angular velocity.

In order to allow the drive arrangement 120, 120′ to be provided as a separate assembly that can be assembled and then shipped to a different location or site for assembly to the engine 10, the hub support 160 is removably connected to the housing 122, preferably via fasteners 61 which are threaded, to provide access for insertion of the fastener 62 for direct connection of the flex-plate coupling 40 to the end 13 of the crankshaft 12 in a similar manner to the hub support 60 described above in connection with the first embodiment of the drive arrangement 20. The fasteners are shown in the assembled state of the drive arrangement 120, 120′ to the engine in FIGS. 8 and 9.

As shown in FIGS. 8 and 9, the at least one access opening 66 is provided in the rotor support 36 in order to allow insertion of the fasteners 62 through the openings 48 and into the end 13 of the crankshaft 12.

The drive arrangements 120, 120′ can be separately assembled in a manner to prevent movement of the rotor 34 within the stator 32, in a similar manner to the drive arrangement 20 as shown in FIGS. 1-4. Specifically, at least some of the opposite tapered or beveled supports 47a of the flex-plate coupling 40 can be formed by a bent portion of the first one of the at least two flex-plates 42a. As shown in FIG. 2, these opposite tapered or beveled supports 47a are pressed against the taper or bevel 23a (123a on the front wall 123 in this embodiment) when the shipping ring 70 is installed. A further seal 18 is also shown that acts between the front wall 123 and the bent portion of the first one of the flex plates 42a. Additionally, at least some of the opposite tapered or beveled supports 47 of the flex-plate coupling 40 can be formed on fastener heads of the fasteners 35 used to connect the flex-plate coupling 40 to the rotor 34. These opposite tapered or beveled supports 47 contact the adjacent flex plate 42a when the shipping ring 70 is installed. If there are more than 2 of the flex plates 42a, 42b, additional ones of the supports can be provided.

Accordingly, the drive arrangements 120, 120′ for P1 hybrid drive applications can have the same benefits as noted above. Further, the various flex-plate coupling 40, 40′, 40″, 40′″ could also be used in a similar manner as described above.

Having thus described the presently preferred embodiments in detail, it is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope that is indicated by the appended claims rather than by the foregoing description, and all alternate embodiments and changes to this embodiment which come within the meaning and range of equivalency of said claims are therefore to be embraced therein.

### LIST OF REFERENCE SYMBOLS

10 engine
12 crankshaft
12a′ spacer
13 end of 12
14 rear wall
15 seal
20, 20′, 20″, 20′″ drive arrangement
22, 22′, 22:″, 22′″ drive housing
23, 23′ front wall
23a taper or bevel
24, 24′, 24″, 24′″ radially outer wall
25, 25′, 25″, 25′″ bolt flange(s)
26, 26′, 26″, 26′″ rear wall
28′ access opening/hole
29, 29′, 29″ chamber
30, 30′, 30″, 30′″ Emotor
32, 32′, 32″, 32′″ stator
34, 34′, 34″, 34′″ rotor
35 rivets
36, 36′, 36″ rotor support
36a first end
36b second end
37 pilot
39 support flange
40, 40′, 40″, 40′″ flex-plate coupling
42a,b, 42a′, b′, 42a″,b″, 42a′″-d′″ flex plates
43a,b, 43a′,b′, 43a″,b″, 43a′″-d′″ first ends
44a,b, 44a′,b′, 44a″,b″, 44a′″-d′″ second ends
46 fasteners
47, 47a tapered or beveled supports
48 openings
60, 60′ hub support
61 fasteners
62 fasteners
64 bearing or bushing
66, 66′, 66″, 68′″ access holes
70 removable shipping ring
72 spring or resilient section
74′ plug
110 output shaft
120, 120′ drive arrangement
122 drive housing
123 front wall
124 radially outer wall
125 bolt flange(s)
126 rear wall
129 chamber
130 Emotor
160 Hub support
161 fasteners
180 opening
182 seal
184 flange
186′ damper arrangement
X axis

1. A drive arrangement adapted for connection to an engine, the drive arrangement comprising:
a drive housing;
an Emotor including a stator and a rotor, the stator being supported in the drive housing;
a flex-plate coupling including at least two flex plates, with fasteners connecting end regions of the at least two flex plates, a first one of the at least two flex-plates including openings that are adapted to receive fasteners for direct connection to an end of a crankshaft of the engine, and a last of the at least two flex plates being connected to the rotor;
the rotor including a rotor support, the rotor support including a pilot at a first end that is adapted to be received in a pilot opening in the end of the crankshaft and a second end with a support flange; and
a hub support that is connected to the drive housing and rotatably supports the support flange of the rotor support.

2. The drive arrangement of claim 1, wherein the hub support is removably connected to the housing to provide access for insertion of the fasteners for direct connection of the flex-plate coupling to the end of the crankshaft.

3. The drive arrangement of claim 1, wherein the hub support is integrally formed with the drive housing and a rear wall of the drive housing that is adapted to face away from the engine in an installed position includes at least one access opening for insertion of the fasteners for direct connection of the flex-plate coupling to the end of the crankshaft.

4. The drive arrangement of claim 1, further comprising at least one of a bearing or bushing between the rotor support and the hub support.

5. The drive arrangement of claim 1, further comprising at least one access opening in at least one of the drive housing, the rotor support, or the flex-plate coupling for insertion of the fasteners for direct connection of the flex-plate coupling to the end of the crankshaft.

6. The drive arrangement of claim 1, wherein an engine side wall of the housing includes a taper or bevel facing the flex-plate coupling, and an opposite taper or beveled supports are connected to or located on the flex-plate coupling that are spaced apart from the taper or bevel on the engine side wall of the housing in an operating state of the drive arrangement, and a removable shipping ring located between the hub support and the rotor that biases the flex-plate coupling so that the opposite taper or beveled supports of the flex-plate coupling contact the taper or bevel on the engine side wall of the housing in a shipping state of the drive arrangement.

7. The drive arrangement of claim 6, wherein at least some of the opposite taper or beveled supports of the flex-plate coupling are formed on fastener heads of fasteners used to connect the flex-plate coupling to the rotor.

8. The drive arrangement of claim 6, wherein at least some of the opposite taper or beveled supports of the flex-plate coupling are formed by a bent portion of the first one of the at least two flex-plates.

9. The drive arrangement of claim 6, wherein the shipping ring includes a spring or resilient section that biases the rotor such that the flex plate is pressed against the taper or bevel on the engine side wall of the housing.

10. The drive arrangement of claim 1, wherein the drive housing includes a radially outer wall and a rear wall, and the radially outer wall is adapted to be connected to a rear wall of the engine.

11. The drive arrangement of claim 10, wherein a chamber is formed between the rear wall of the engine, the radially outer wall and the rear wall of the drive housing in which the stator and rotor are located.

12. The drive arrangement of claim 1, wherein the flex-plate coupling is located at least partially within the rotor in a longitudinal direction of the drive train.

13. The drive arrangement of claim 1, further comprising an output shaft that is drivingly connected to the rotor and extends through the hub support.

14. A method of installing a drive arrangement on an engine, the method comprising:
providing a drive arrangement including a drive housing, an Emotor including a stator and a rotor, with the stator being supported in the drive housing, a flex-plate coupling including at least two flex plates, with fasteners connecting end regions of the at least two flex plates, a first one of the at least two flex-plates including openings that are adapted to receive fasteners for direct connection to an end of a crankshaft of the engine, and a last of the at least two flex plates being connected to the rotor, the rotor includes a rotor support, with the rotor support including a pilot at a first end that is adapted to be received in a pilot opening in the end of the crankshaft and a second end with a support flange, and a hub support that is connected to the drive housing and rotatably supports the support flange of the rotor support, with a removable shipping ring located between the hub support and the rotor that biases the flex-plate coupling against an engine side wall of the housing in a shipping state of the drive arrangement;
removing the hub support;
removing the shipping ring;
inserting the pilot at the first end of the rotor support into the pilot opening in the end of the crankshaft;
installing fasteners through the openings in the first one of the at least two flex plates to connect the flex-plate coupling to the end of the crankshaft; and
reinstalling the hub support to rotatably support the support flange of the rotor support.

15. The method of claim 14, further comprising fastening the drive housing to a rear wall of the engine.

16. The method of claim 14, wherein the step of installing the fasteners includes inserting the fasteners through at least one access opening in at least one of the drive housing, the rotor support, or the flex-plate coupling to the openings in the first one of the at least two flex plates for direct connection of the flex-plate coupling to the end of the crankshaft.

17. The method of claim 14, wherein the flex-plate coupling is located at least partially within the rotor in a longitudinal direction of the drive train.
